(19) United States
(12) Patent Application Publication
(10) Pub. No.: US 2026/0269214 A1
(43) Pub. Date: Sep. 10, 2026

(54) DRYING DEVICE AND DRYING METHOD

(71) Applicant: HONDA MOTOR CO., LTD., Tokyo (JP)

(72) Inventors: Hiroki Ichihara, Wako-shi (JP); Hikaru Sato, Wako-shi (JP); Mitsuhiro Sada, Wako-shi (JP); Tomoya Oyama, Wako-shi (JP)

(21) Appl. No.: 19/539,112

(22) Filed: Feb. 13, 2026

(30) Foreign Application Priority Data
Mar. 6, 2025 (JP) 2025-035370

(51) Int. Cl. H01M 4/131; F26B 3/30; H01M 4/525; H01M 10/052; H01M 10/0525

(52) U.S. Cl. CPC H01M 4/131; F26B 3/30; H01M 4/525; H01M 10/052; H01M 10/0525

(57) ABSTRACT

A drying device configured to perform in a furnace, after applying a positive electrode forming material containing a binder, a first drying step of increasing a temperature, an intermediate step of promoting back diffusion of the binder, and a second drying step of performing drying to a desired dry state, wherein the device is characterized in that the temperature in the intermediate step is 10°C or more lower than those in the first drying step and the second drying step.

### CROSS-REFERENCE TO RELATED APPLICATION

Priority is claimed on Japanese Patent Application No. 2025-035370, filed March 6, 2025, the content of which is incorporated herein by reference.

### BACKGROUND OF THE INVENTION

### Field of the Invention

The present invention relates to a drying device and a drying method.

### Description of Related Art

In recent years, research and development into all-solid-state batteries, which contribute to energy efficiency, has been underway to ensure more people have access to affordable, reliable, sustainable, and advanced energy (see, for example, International Publication No. WO 2011/136041).

In the mass production of all-solid-state electrodes, a hot air drying process is widely known as a low-cost drying method. The hot air drying process has a problem that shortening a drying time causes a phenomenon (migration) in which a binder in an electrode precipitates on a surface layer, resulting in a decrease in peel strength. A decrease in peel strength of an electrode has a significant impact on the performance of all-solid-state batteries, particularly direct current resistance (DCR).

### SUMMARY OF THE INVENTION

Aspects of the present invention provide a drying device and a drying method, with which high-performance all-solid-state electrodes can be manufactured at low cost. Aspects of the present invention contribute to energy efficiency.

A drying device of Aspect 1 of the present invention is a drying device configured to perform in a furnace, after applying a positive electrode forming material containing a binder, a first drying step of increasing a temperature, an intermediate step of promoting back diffusion of the binder, and a second drying step of performing drying to a desired dry state, in which the temperature in the intermediate step is 10°C or more lower than those in the first drying step and the second drying step.

By lowering the temperature in the intermediate step by 10°C or more, the binder that has accumulated on a surface of a positive electrode temporarily precipitates through the back diffusion. Thus, even if an application time of the positive electrode forming material is shortened, a decrease in peel strength of the positive electrode is inhibited. Accordingly, a high-performance all-solid-state electrode can be manufactured at low cost.

A drying device of Aspect 2 is based on the drying device of Aspect 1. The temperature in the first drying step may be set to a temperature higher than 50°C and equal to or lower than 90°C or a temperature at which segregation does not occur.

A drying device of Aspect 3 is based on the drying device of Aspect 1. The second drying step may be performed at a temperature between 70°C and 100°C.

Thus, the positive electrode forming material is in a completely dried state after the second drying step is completed. Also, the peel strength of the positive electrode is increased.

A drying device of Aspect 4 is based on the drying device of Aspect 3. The second drying step may be performed at a higher temperature than the first drying step.

Since part of a solvent in the positive electrode forming material evaporates in the first drying step, the binder is less likely to diffuse through the solvent in the second drying step. For that reason, the temperature in the second drying step can be higher than that in the first drying step. Thus, the positive electrode forming material is in a completely dried state after the second drying step is completed.

A drying device of Aspect 5 is based on the drying device of Aspect 1. When a flow direction of the positive electrode forming material is defined as a first direction and a direction orthogonal to the first direction is defined as a second direction, the drying in the first drying step, the intermediate step, and the second drying step may be performed within a temperature range in which the peel strength of the positive electrode in the first direction is greater than the peel strength of the positive electrode in the second direction.

Thus, the peel strength of the positive electrode is increased.

A drying device of Aspect 6 is based on the drying device of Aspect 1. Heating in the second drying step may be performed from a position physically closer to the positive electrode forming material than in the first drying step.

Thus, the temperature in the second drying step is higher than in the first drying step. Thus, the positive electrode forming material is in a completely dried state after the second drying step is completed.

A drying device of Aspect 7 is based on the drying device of Aspect 1. In the intermediate step, the positive electrode forming material may be cooled at room temperature.

Thus, the back diffusion of the binder is promoted. In addition, energy consumption in the intermediate step is inhibited.

A drying device of Aspect 8 is based on the drying device of Aspect 1. The temperature in the second drying step may be rapidly increased from the intermediate step.

Thus, the positive electrode forming material transforms from a slurry into a uniform powder.

A drying device of Aspect 9 is based on the drying device of Aspect 1. Heating may be performed from an upper portion of the positive electrode forming material in the first drying step, the intermediate step, and the second drying step. Thus, the binder that has accumulated in the upper portion of the positive electrode forming material moves to its lower portion due to its own weight and the back diffusion, and becomes uniform.

A drying device of Aspect 10 is based on the drying device of Aspect 1. The positive electrode forming material may contain a positive electrode active material, and the positive electrode active material may be lithium nickel-cobalt-manganese oxide.

A drying device of Aspect 11 is based on the drying device of Aspect 1. The positive electrode forming material may contain a solid electrolyte, and the solid electrolyte may be a sulfide-based material.

A drying device of Aspect 12 is based on the drying device of Aspect 1. The positive electrode forming material may contain a solvent, and the solvent may be butyl butyrate.

A drying device of Aspect 13 is based on the drying device of Aspect 1. The positive electrode forming material may contain a binder, and the binder may be a polyvinylidene fluoride-based material.

Thus, a high-performance all-solid-state electrode can be manufactured at low cost.

A drying method of Aspect 14 of the present invention is a drying method of performing in a furnace, after applying a positive electrode forming material containing a binder, a first drying step of increasing a temperature, an intermediate step of promoting back diffusion of the binder, and a second drying step of performing drying to a desired dry state, in which a temperature in the intermediate step is 10°C or more lower than those in the first drying step and the second drying step, the temperature in the first drying step is set to be higher than 50°C and equal to or lower than 90°C or a temperature at which segregation does not occur, and the temperature in the second drying step is between 70°C and 100°C.

By lowering the temperature in the intermediate step by 10°C or more, the binder that has accumulated on the surface of the positive electrode temporarily precipitates through the back diffusion. Thus, even if the application time of the positive electrode forming material is shortened, a decrease in the peel strength of the positive electrode is inhibited. Accordingly, a high-performance all-solid-state electrode can be manufactured at low cost. Also, the positive electrode forming material is in a completely dried state after the second drying step is completed. In addition, the peel strength of the positive electrode is increased.

A drying method of Aspect 15 of the present invention is based on the drying method of Aspect 14. Heating in the second drying step may be performed from a position physically closer to the positive electrode forming material than in the first drying step.

Thus, the positive electrode forming material is in a completely dried state after the second drying step is completed.

A drying method of Aspect 16 of the present invention is based on the drying method of Aspect 14. In the intermediate step, the positive electrode forming material may be cooled at room temperature.

Thus, the back diffusion of the binder is promoted. Also, energy consumption in the intermediate step is inhibited.

A drying method of Aspect 17 of the present invention is based on the drying method of Aspect 14. The temperature in the second drying step may be rapidly increased from the intermediate step.

Thus, the positive electrode forming material transforms from a slurry into a uniform powder.

A drying method of Aspect 18 of the present invention is based on the drying method of Aspect 14. Heating is performed from an upper portion of the positive electrode forming material in the first drying step, the intermediate step, and the second drying step.

Thus, the binder that has accumulated in the upper portion of the positive electrode forming material moves to a lower portion thereof due to its own weight and the back diffusion, and becomes uniform.

According to the aspects of the present invention, a high-performance all-solid-state electrode can be manufactured at low cost.

### BRIEF DESCRIPTION OF THE DRAWINGS

FIG. 1 shows a schematic configuration diagram of a drying device according to an embodiment and a graph showing a change in temperature inside a positive electrode.

FIG. 2 is a graph showing experimental results obtained by changing a first temperature in a first drying step to measure a peel strength and a change in weight of the positive electrode.

FIG. 3 is a graph showing experimental results obtained by changing a third temperature in a second drying step to measure a peel strength and a change in weight of the positive electrode.

FIG. 4 is a graph showing a distribution of binder concentration inside the positive electrode according to the embodiment.

FIG. 5 is a graph showing a distribution of binder concentration inside a positive electrode according to a comparative example.

### DETAILED DESCRIPTION OF THE INVENTION

Embodiments of the present invention will be described below with reference to the drawings.

An all-solid-state battery is configured by laminating a positive electrode layer, a solid electrolyte layer, and a negative electrode layer. The positive electrode layer is configured of a positive electrode active material layer and a positive electrode current collector foil. The negative electrode layer is configured of a negative electrode active material layer and a negative electrode current collector foil.

The solid electrolyte layer is made of a solid electrolyte with ionic conductivity. As a material for the solid electrolyte layer, a sulfide-based solid electrolyte material can be exemplified.

The positive electrode current collector foil is made of a conductive material such as aluminum (Al).

As an active material that forms the positive electrode active material layer, for example, a ternary material such as lithium nickel-cobalt-manganese oxide (NCM) can be exemplified. In particular, NCM712 is a ternary material with a nickel:cobalt:manganese ratio of 7:1:2.

The positive electrode active material layer is formed by applying a material for forming a positive electrode (hereinafter sometimes referred to as a positive electrode forming material) to a surface of the positive electrode current collector foil. The positive electrode forming material includes an active material, a binder, and a solvent. The solvent is, for example, butyl butyrate. The binder is, for example, a polyvinylidene fluoride (PVDF)-based material. The binder binds the active material to the positive electrode current collector foil.

A drying device and a drying method of embodiments are used to dry the positive electrode forming material applied to the surface of the positive electrode current collector foil.

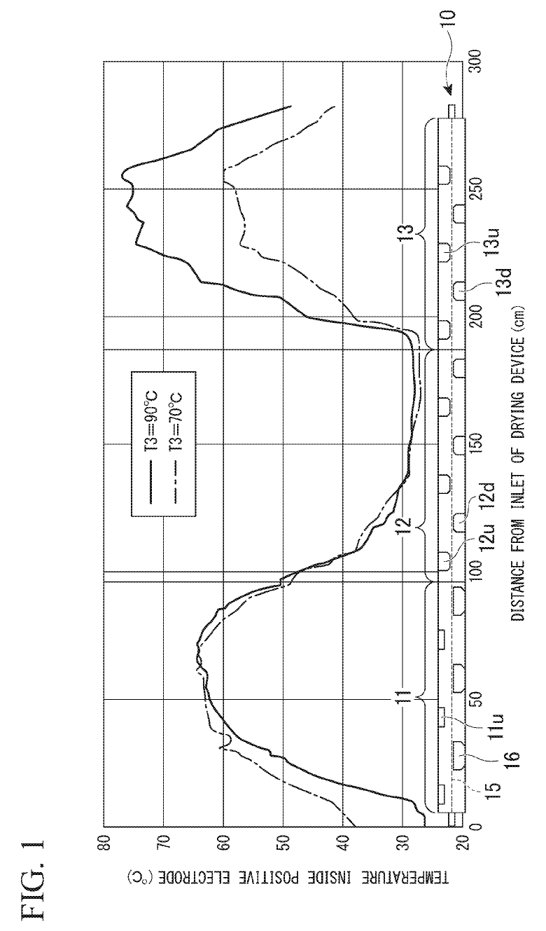

FIG. 1 shows a schematic configuration diagram of a drying device 10 according to an embodiment and a graph showing a change in temperature inside the positive electrode. The horizontal axis of the graph in FIG. 1 indicates a distance from an inlet of the drying device 10. The schematic configuration diagram of the drying device 10 as viewed from its lateral side is shown below the graph in FIG. 1. The drying device 10 has a workpiece transport path 15. The workpiece is the positive electrode current collector foil coated with the positive electrode forming material. The workpiece is transported at a constant speed along the transport path 15. The transport path 15 is, for example, linear. The drying device 10 has a first furnace 11, a second furnace 12, and a third furnace 13 along the transport path 15.

The first furnace 11, the second furnace 12, and the third furnace 13 each have a heater. The heater heats dehumidified dry air and sprays it toward the positive electrode forming material. Thus, heat is transferred from a surface to the inside of the positive electrode forming material to evaporate and dry the solvent in the positive electrode forming material.

The first furnace 11 has a floater 16 and an upper heater 11u. The floater 16 is disposed below the transport path 15. The floater 16 blows air toward the transport path 15 to transport the workpiece. The upper heater 11u is disposed above and spaced apart from the transport path 15. The upper heater 11u blows hot air toward the transport path 15, raising a temperature of the first furnace 11 to a first temperature T1. A plurality of floaters 16 and a plurality of upper heaters 11u are arranged along the transport path 15.

The second furnace 12 has a lower heater 12d and an upper heater 12u. The lower heater 12d is disposed below the transport path 15, and the upper heater 12u is disposed above the transport path 15. The lower heater 12d and the upper heater 12u blow hot air toward the transport path 15, raising a temperature of the second furnace 12 to a second temperature T2. A plurality of lower heaters 12d and a plurality of upper heaters 12u are arranged along the transport path 15. As described below, the second furnace 12 is set to room temperature, and thus the second furnace 12 may not be provided with the lower heater 12d and the upper heater 12u. When the second furnace 12 is set to room temperature, the power to the lower heater 12d and the upper heater 12u may be turned off.

The third furnace 13 has a lower heater 13d and an upper heater 13u. The lower heater 13d is disposed below the transport path 15, and the upper heater 13u is disposed above the transport path 15. The upper heater 13u of the third furnace 13 is disposed closer to the transport path 15 than the upper heater 11u of the first furnace 11. The lower heater 13d and the upper heater 13u blow hot air toward the transport path 15, raising a temperature of the third furnace 13 to a third temperature T3. A plurality of lower heaters 13d and a plurality of upper heaters 13u are arranged along the transport path 15.

The drying method of the present embodiment includes a first drying step, an intermediate step, and a second drying step.

The first drying step is performed in the first furnace 11. In the first drying step, the positive electrode forming material is dried at the first temperature T1. In the first drying step, some of the solvent contained in the positive electrode forming material is evaporated. The first drying step is a binder diffusion step. In the binder diffusion step, the binder contained in the positive electrode forming material migrates toward the surface of the positive electrode forming material (a side opposite to the positive electrode current collector foil).

The intermediate step is performed in the second furnace 12. In the intermediate step, the positive electrode forming material is cooled at the second temperature T2. The second drying step is a binder back diffusion step. In the binder back diffusion step, the binder contained in the positive electrode forming material migrates reversely toward the positive electrode current collector foil. The second temperature T2 is preferably room temperature. Thus, back diffusion of the binder is promoted. In addition, energy consumption in the intermediate step is inhibited.

The second drying step is performed in the third furnace 13. In the second drying step, the positive electrode forming material is dried at the third temperature T3. The second drying step is a complete drying process. In the second drying step, most of the solvent contained in the positive electrode forming material is evaporated, and the positive electrode forming material is dried to a desired dry state.

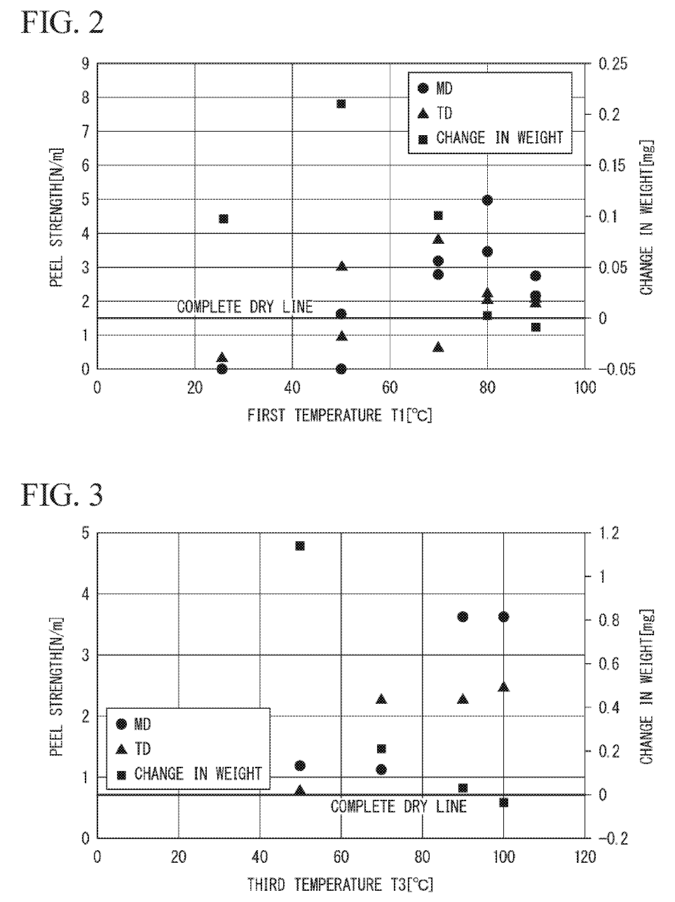

FIG. 2 is a graph showing experimental results obtained by changing the first temperature T1 in the first drying step to measure a peel strength and a change in weight of the positive electrode. The first temperature T1 in the first drying step is one of five temperatures, that is, room temperature (25°C), 50°C, 70°C, 80°C, and 90°C. The second temperature T2 in the second drying step is room temperature, and the third temperature T3 in the third drying step is 100°C.

After the second drying step is completed, the peel strength and the change in weight of the positive electrode are measured. The peel strength is a peel strength between the positive electrode current collector foil and the positive electrode active material layer. The peel strength in the flow direction of the positive electrode forming material is machine direction (MD). The peel strength in a direction perpendicular to the flow direction of the positive electrode forming material is transverse direction (TD). The change in weight is a change in weight after the second drying step is completed. When the change in weight is zero, the positive electrode forming material is in a completely dried state after the second drying step is completed.

When the first temperature T1 is 80°C or 90°C, the positive electrode forming material is almost in a completely dried state after the second drying step is completed. When the first temperature T1 is 80°C, the peel strength is highest. In this case, MD is larger than TD. Based on the above results, the first temperature T1 of 80°C is considered optimal.

FIG. 3 is a graph showing experimental results obtained by changing the third temperature T3 in the second drying step to measure the peel strength and the change in weight of the positive electrode. The first temperature T1 in the first drying step is 80°C, and the second temperature T2 in the second drying step is room temperature. The third temperature T3 in the third drying step is one of four temperatures, that is, 50°C, 70°C, 90°C, and 100°C.

After the second drying step is completed, the peel strength and the change in weight of the positive electrode are measured. Definitions of the peel strength and the change in weight are the same as in FIG. 2.

When the third temperature T3 is 90°C or 100°C, the positive electrode forming material is almost in a completely dried state after the second drying step is completed. When the third temperature T3 is 100°C, the peel strength is highest. In this case, MD is larger than TD. Based on the above results, the third temperature T3 of 100°C is considered optimal.

The second temperature T2 in the intermediate step is room temperature. The room temperature in the intermediate step is at least 10°C lower than the 80°C in the first drying step and the 100°C in the second drying step. Thus, the binder that has accumulated on a surface of the positive electrode is temporarily precipitated due to the back diffusion. Thus, even when an application time of the positive electrode forming material is shortened, a decrease in the peel strength of the positive electrode is inhibited. Accordingly, a high-performance all-solid-state electrode can be manufactured at low cost.

The temperature of 100°C in the second drying step is higher than the 80°C in the first drying step. Since some of the solvent in the positive electrode forming material evaporates in the first drying step, the binder is less likely to diffuse through the solvent in the second drying step. For that reason, the third temperature T3 in the second drying step can be set higher than the first temperature T1 in the first drying step. Thus, the positive electrode forming material is in a completely dried state after the second drying step is completed.

As shown in FIG. 1, the upper heater 13u of the third furnace 13 of the drying device 10 is disposed closer to the transport path 15 than the upper heater 11u of the first furnace 11. In the second drying step, heating is performed from a position physically closer to the positive electrode forming material than in the first drying step. Thus, the third temperature T3 in the second drying step can be set higher than the first temperature T1 in the first drying step. As a result, the positive electrode forming material is in a completely dried state after the second drying step is completed.

The upper heater 11u of the first furnace 11, the upper heater 12u of the second furnace 12, and the upper heater 13u of the third furnace 13 are disposed above the transport path 15 and blow hot air toward the transport path 15. In the first drying step, the intermediate step, and the second drying step, the positive electrode forming material is heated from above. Thus, the binder that has accumulated in an upper portion of the positive electrode forming material moves to a lower portion thereof due to its own weight and the back diffusion, becoming uniform. Further, the positive electrode forming material can be dried efficiently.

FIG. 1 shows a graph of a change in temperature inside the positive electrode in each step of the drying method of the present embodiment. The first temperature T1 of the first furnace 11 is set to 80°C, and the second temperature T2 of the second furnace 12 is set to room temperature. The third temperature T3 of the third furnace 13 is set to two temperatures, that is, 90°C and 70°C. The 90°C temperature is indicated by a solid line, and the 70°C temperature is indicated by a dashed-dotted line.

The temperature inside the positive electrode in the first drying step is slightly lower than the first temperature T1 of 80°C. The temperature inside the positive electrode in the intermediate step is slightly higher than the second temperature T2, which is room temperature. The temperature inside the positive electrode in the second drying step is slightly lower than the third temperature T3 of 90°C or 70°C. The temperature inside the positive electrode rises sharply from the intermediate step to the second drying step. In this case, it is believed that the positive electrode forming material transforms from a slurry into a uniform powder.

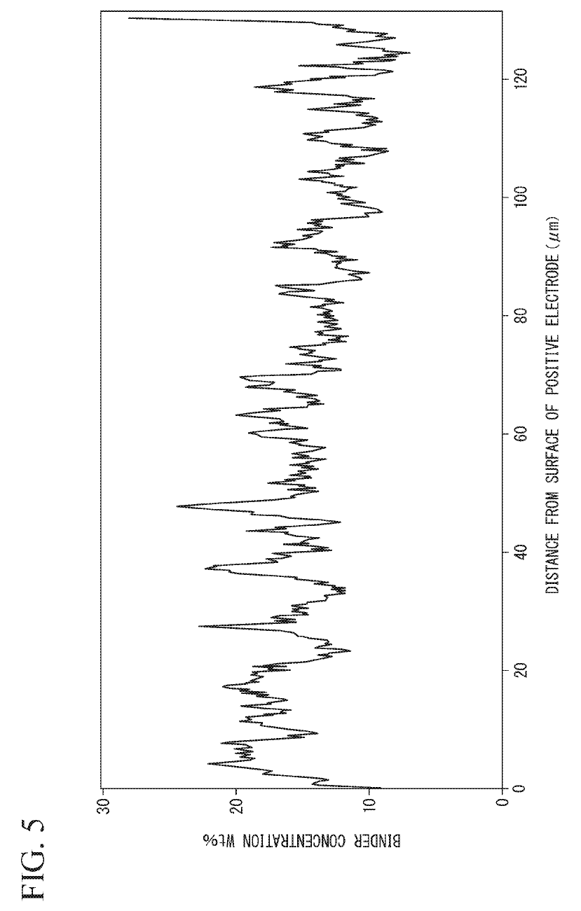

FIG. 5 is a graph showing a distribution of binder concentration inside the positive electrode in a comparative example. The horizontal axis of FIG. 5 indicates a distance from the surface of the positive electrode toward the positive electrode current collector foil. The vertical axis of FIG. 5 indicates the binder concentration. In the comparative example, the application time of the positive electrode forming material is long, and some of the positive electrode forming material dries during application. FIG. 5 shows the distribution of binder concentration after the positive electrode forming material has completely dried. In the comparative example, the binder is distributed generally evenly from the surface of the positive electrode to an interface with the positive electrode current collector foil. It is believed that segregation of the binder is inhibited due to slow drying of the positive electrode forming material during application.

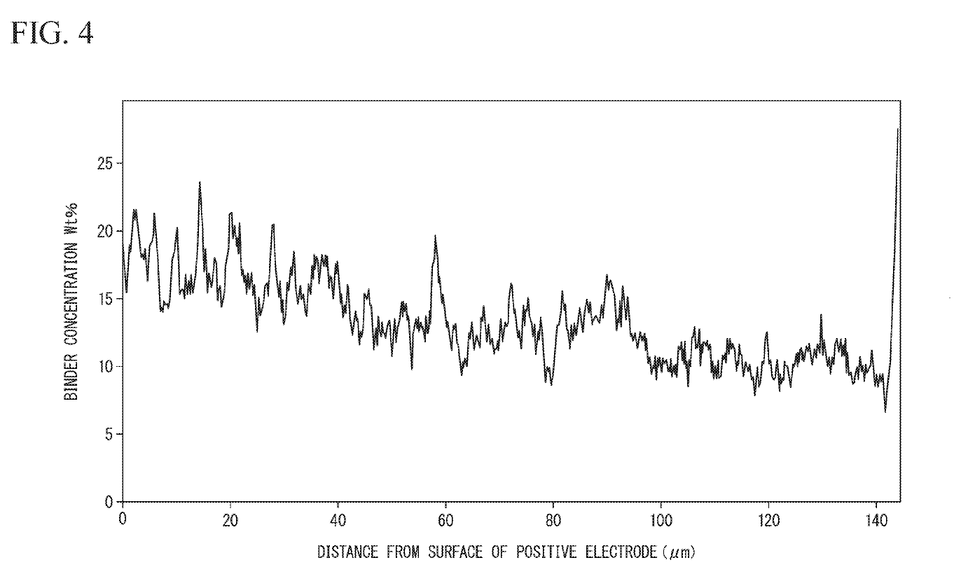

FIG. 4 is a graph showing a distribution of binder concentration inside the positive electrode according to the embodiment. In the embodiment, the application time of the positive electrode forming material is shorter than in the comparative example. FIG. 4 shows the distribution of binder concentration after the positive electrode forming material has completely dried using the drying method of the embodiment. In the embodiment, the binder is also distributed generally evenly from the surface of the positive electrode to the interface with the positive electrode current collector foil. Even if the application time of the positive electrode forming material is short, segregation of the binder is inhibited by the drying method of the embodiment.

As described in detail above, the drying device 10 of the present embodiment is the drying device 10 that performs in each furnace, after applying the positive electrode forming material containing the binder, the first drying step of increasing the temperature, the intermediate step of promoting the back diffusion of the binder, and the second drying step of performing drying to the desired dry state, and is characterized in that the temperature in the intermediate step is at least 10°C lower than in the first and second drying steps.

By lowering the temperature in the intermediate step by 10°C or more, the binder that has accumulated on the surface of the positive electrode temporarily precipitates by the back diffusion. Thus, even if the application time of the positive electrode forming material is shortened, a decrease in the peel strength of the positive electrode is inhibited. Accordingly, a high-performance all-solid-state electrode can be manufactured at low cost.

The temperature in the first drying step is preferably set to be higher than 50°C and equal to or lower than 90°C or a temperature at which segregation does not occur.

The temperature in the second drying step is preferably between 70°C and 100°C.

Thus, the positive electrode forming material is in a completely dried state after the second drying step is completed. Further, the peel strength of the positive electrode is increased.

In the intermediate step, the positive electrode forming material is preferably cooled at room temperature.

Thus, the back diffusion of the binder is promoted. Further, energy consumption in the intermediate step is reduced.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A drying device configured to perform in a furnace, after applying a positive electrode forming material containing a binder, a first drying step of increasing a temperature, an intermediate step of promoting back diffusion of the binder, and a second drying step of performing drying to a desired dry state,
wherein the temperature in the intermediate step is 10°C or more lower than those in the first drying step and the second drying step.

2. The drying device according to claim 1, wherein the temperature in the first drying step is set to a temperature higher than 50°C and equal to or lower than 90°C or a temperature at which segregation does not occur.

3. The drying device according to claim 1, wherein the second drying step is performed at a temperature between 70°C and 100°C.

4. The drying device according to claim 3, wherein the second drying step is performed at a higher temperature than the first drying step.

5. The drying device according to claim 1,
wherein, when a flow direction of the positive electrode forming material is defined as a first direction and a direction orthogonal to the first direction is defined as a second direction,
the drying in the first drying step, the intermediate step, and the second drying step is performed within a temperature range in which a peel strength of the positive electrode in the first direction is greater than a peel strength of the positive electrode in the second direction.

6. The drying device according to claim 1, wherein heating in the second drying step is performed from a position physically closer to the positive electrode forming material than in the first drying step.

7. The drying device according to claim 1, wherein, in the intermediate step, the positive electrode forming material is cooled at room temperature.

8. The drying device according to claim 1, wherein the temperature in the second drying step is rapidly increased from the intermediate step.

9. The drying device according to claim 1, wherein heating is performed from an upper portion of the positive electrode forming material in the first drying step, the intermediate step, and the second drying step.

10. The drying device according to claim 1, wherein the positive electrode forming material contains a positive electrode active material, and the positive electrode active material is lithium nickel-cobalt-manganese oxide.

11. The drying device according to claim 1, wherein the positive electrode forming material contains a solid electrolyte, and the solid electrolyte is a sulfide-based material.

12. The drying device according to claim 1, wherein the positive electrode forming material contains a solvent, and the solvent is butyl butyrate.

13. The drying device according to claim 1, wherein the positive electrode forming material contains a binder, and the binder is a polyvinylidene fluoride-based material.

14. A drying method of performing in a furnace, after applying a positive electrode forming material containing a binder, a first drying step of increasing a temperature, an intermediate step of promoting back diffusion of the binder, and a second drying step of performing drying to a desired dry state,
wherein the temperature in the intermediate step is 10°C or more lower than those in the first drying step and the second drying step,
the temperature in the first drying step is set to be higher than 50°C and equal to or lower than 90°C or a temperature at which segregation does not occur, and
the temperature in the second drying step is between 70°C and 100°C.

15. The drying method according to claim 14, wherein heating in the second drying step is performed from a position physically closer to the positive electrode forming material than in the first drying step.

16. The drying method according to claim 14, wherein, in the intermediate step, the positive electrode forming material is cooled at room temperature.

17. The drying method according to claim 14, wherein the temperature in the second drying step is rapidly increased from the intermediate step.

18. The drying method according to claim 14, wherein heating is performed from an upper portion of the positive electrode forming material in the first drying step, the intermediate step, and the second drying step.
